(19) United States
(12) Patent Application Publication
(10) Pub. No.: US 2026/0148144 A1
(43) Pub. Date: May 28, 2026

(54) COMBINATORIAL OPTIMIZATION SYSTEM, ITS CONTROL METHOD, AND LEARNING METHOD OF COMBINATORIAL OPTIMIZATION SYSTEM

(71) Applicant: LG MANAGEMENT DEVELOPMENT INSTITUTE CO., LTD., Seoul (KR)

(72) Inventors: Deun Sol YOON, Seoul (KR); Hyung Seok SONG, Seoul (KR); Kang Hoon LEE, Seoul (KR); Woo Hyung LIM, Seoul (KR)

(21) Appl. No.: 19/454,349

(22) Filed: Jan. 20, 2026

Related U.S. Application Data
(63) Continuation of application No. PCT/KR2025/007192, filed on May 27, 2025.

(30) Foreign Application Priority Data
Jun. 24, 2024 (KR) 10-2024-0082166
Apr. 29, 2025 (KR) 10-2025-0056404

(51) Int. Cl. G06N 20/00

(52) U.S. Cl. CPC G06N 20/00

(57) ABSTRACT

A combinatorial optimization system, its control method, and a learning method of a combinatorial optimization system. The learning method includes specifying a training dataset including at least one combinatorial optimization problem instance and at least one reference solution corresponding to the instance; performing supervised learning on a combinatorial optimization model using the training dataset; acquiring a supervised-learned combinatorial optimization model based on the training data; and performing reinforcement learning on the supervised-learned combinatorial optimization model.

### CROSS REFERENCE TO RELATED APPLICATIONS

This application is a Bypass Continuation of International Patent Application No. PCT/KR2025/007192, filed on May 27, 2025, which claims priority from and the benefit of Korean Patent Application No. 10-2024-0082166, filed on Jun. 24, 2024, and Korean Patent Application No. 10-2025-0056404, filed on Apr. 29, 2025, each of which is hereby incorporated by reference for all purposes as if fully set forth herein.

### BACKGROUND

### Field

Embodiments of the invention relate generally inventionto a combinatorial optimization system, its control method and, more particularly, to a learning method of a combinatorial optimization system.

### Discussion of the Background

Combinatorial optimization (“CO”) problems play a key role in various fields, including operation research, computer science, logistics, circuit design (e.g., PCB design), etc. However, most combinatorial optimization problems are classified as NP-hard, and significant computational resources are required to derive solutions due to the size of a solution space and the complexity of constraints.

In the field of combinatorial optimization, algorithms that do not traditionally employ machine learning have primarily been used. For example, dynamic programming, a greedy algorithm, and branch and bound have been widely used. However, these algorithms are either specialized for specific combinatorial optimization problems or have the limitation of being very slow.

Accordingly, recently, studies utilizing machine learning (“ML”) to solve the combinatorial optimization problems have been actively underway. These studies show the possibility of solving combinatorial optimization problems using data-driven approaches. These machine learning-based combinatorial optimization solutions may be classified into supervised learning (“SL”) and reinforcement learning (“RL”). The difference between the supervised learning and the reinforcement learning lies in the presence or absence of a labeled training dataset that contains solutions to combinatorial optimization problem instances.

For example, the supervised learning is a scheme of imitating (or simulating) a training dataset including high-quality solutions. Recently, studies have been published on applying generative models, such as diffusion models, which have achieved success in image and natural language processing, to the combinatorial optimization problems. However, since the conventional diffusion model does not consider cost information during the learning process, significant differences in actual costs may occur even if the quality of the generated solutions appears similar.

Reinforcement learning aims at cost optimization, and thus, has the advantage of effectively addressing such problems, but has limitations in that it is difficult to learn in large-scale problems where rewards are scarce and variance is large.

Therefore, there is still a need for a method for solving combinatorial optimization problems.

The above information disclosed in this Background section is only for understanding of the background of the inventive concepts, and, therefore, it may contain information that does not constitute prior art.

### SUMMARY

A combinatorial optimization system according to embodiments of the invention are capable of generating an optimal solution to a combinatorial optimization (“CO”) problem, its control method, and a learning method of a combinatorial optimization system.

More specifically, embodiments of the invention are directed to providing a combinatorial optimization model capable of generating an optimal solution that minimizes cost while satisfying constraints of a combinatorial optimization problem instance.

Furthermore, embodiments of the invention are directed to providing a combinatorial optimization model that can be universally utilized in combinatorial optimization problems of various scales.

In addition, the embodiments of the invention are directed to providing a learning method of a combinatorial optimization model capable of addressing the problem of a lack of high-quality training data and generating high-quality solutions.

Furthermore, the embodiments of the invention are directed to providing a learning method of a combinatorial optimization model capable of generating high-quality solutions while satisfying constraints.

Additional features of the inventive concepts will be set forth in the description which follows, and in part will be apparent from the description, or may be learned by practice of the inventive concepts.

According to one or more embodiments of the invention, a computerized learning method of a combinatorial optimization system includes: specifying a training dataset including at least one combinatorial optimization problem instance and at least one reference solution corresponding to the instance; performing supervised learning on a combinatorial optimization model using the training dataset; acquiring a supervised-learned combinatorial optimization model based on the training data; and performing reinforcement learning on the supervised-learned combinatorial optimization model.

At least one parameter of the combinatorial optimization model may be learned based on the supervised learning; the supervised learning is performed to approximate a conditional distribution of the reference solution corresponding to the instance included in the training dataset; and the reinforcement learning may be performed on the combinatorial optimization model using the parameter of the supervised-learned combinatorial optimization model.

The parameter of the combinatorial optimization model may be learned so that a probability distribution of at least one solution sampled from the combinatorial optimization model approximates the conditional distribution of the optimal solution.

In the performing of the supervised learning, the combinatorial optimization model may be trained through a diffusion process, and the diffusion process may include a forward noising process and a backward denoising process.

The combinatorial optimization model may be trained to gradually add noise to the reference solution through the forward noising process to generate solutions with added noise, and trained to restore the solutions to a solution approximating the reference solution by gradually removing noise included in the solutions generated by the forward noising process through the backward denoising process.

The combinatorial optimization model may be trained to approximate the conditional distribution of the reference solution from the solutions generated by the forward noising process.

The parameter of the combinatorial optimization model may be learned by optimizing a first objective function to approximate the conditional distribution of the reference solution from the solutions generated by the forward noising process.

The solution restored to approximate the reference solution may be acquired as a restoration result of the combinatorial optimization model, and the restored solution may be converted into a solution satisfying preset constraints for the instance using a decoder.

In the performing of the reinforcement learning, the supervised-learned combinatorial optimization model may be reinforced-learned using the solution satisfying the constraints.

The performing of the reinforcement learning may include: calculating a cost for a solution satisfying the constraints using a cost function; calculating a reward related to the cost using a reward function; and providing the reward to the supervised-learned combinatorial optimization model.

In the providing of the reward, the reward may be provided for the restored solution acquired as the restoration result of the combinatorial optimization model.

In the performing of the reinforcement learning, the reinforcement learning may be performed on the supervised-learned combinatorial optimization model in consideration of the solution satisfying the constraints and the cost.

The supervised-learned combinatorial optimization model may be trained based on a condition for maximizing the reward related to the cost.

The parameter of the supervised-learned combinatorial optimization model may be learned by optimizing a second objective function so that the cost for the solution satisfying the constraint is minimized.

In the performing of the reinforcement learning, the reinforcement learning-based fine-tuning (“RL fine-tuning”) may be performed on the parameter of the supervised-learned combinatorial optimization model to optimize the second objective function.

In the performing of the reinforcement learning, a training instance may be generated from a distribution of a pre-specified instance or is sampled from the instances included in the training dataset.

According to yet another embodiment of the invention, a control method of a combinatorial optimization system includes: receiving at least one combinatorial optimization problem instance from a user terminal; processing the instance as input to a combinatorial optimization model trained through supervised learning and reinforcement learning; acquiring an at least one solution to the instance from the combinatorial optimization model; and providing the at least one solution to the user terminal as an optimized solution.

In the receiving of the combinatorial optimization problem instance, PCB data corresponding to the instance and including constraint information may be received from a service page provided to the user terminal and, in the acquiring of the at least one solution, an optimized path corresponding to the optimized solution may be generated using the combinatorial optimization model, in which the optimized path wires terminals included in the PCB data at a minimum cost while satisfying the constraint information.

In the providing of the optimized solution to the user terminal, the optimized path, in which the terminals may be wired at a minimum cost, while satisfying the constraints according to the constraint information, is provided to the user terminal.

According to yet another embodiment of the invention, a combinatorial optimization system includes: a memory configured to store executable instructions and one or more processors configured to perform an operation by executing one or more instructions, wherein the combinatorial optimization system specifies a training dataset including at least one combinatorial optimization problem instance and at least one reference solution corresponding to the instance, performs supervised learning on a combinatorial optimization model using the training dataset, acquires a supervised-learned combinatorial optimization model based on the training data, and performs reinforcement learning on the supervised-learned combinatorial optimization model.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 is a conceptual diagram for describing a combinatorial optimization system according to embodiments of the invention.

FIG. 2A and FIG. 2B are conceptual diagrams for describing a training dataset according to the embodiments of the invention.

FIGS. 3A and 3B are flowcharts for describing a learning method of a combinatorial optimization system according to embodiments of the invention.

FIG. 4, FIG. 5, FIG. 6, FIG. 7, FIG. 8, FIG. 9, FIG. 10, FIG. 11, FIG. 12, FIG. 13, and FIG. 14 are conceptual diagrams for describing the learning method of a combinatorial optimization system according to embodiments of the invention.

FIG. 15 is a flowchart for describing a control method of a combinatorial optimization system according to embodiments of the invention.

### DETAILED DESCRIPTION

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Hereafter, embodiments of the invention disclosed in the present specification will be described in detail with reference to the accompanying drawings and the same or similar components are given the same reference numerals regardless of the numbers of figures and are not repeatedly described. In addition, terms “module” and “unit” for components used in the following description are used only to easily make the disclosure. Therefore, these terms do not have meanings or roles that distinguish from each other in themselves. Further, it should be understood that the accompanying drawings are provided only in order to allow embodiments disclosed in the present specification to be easily understood, and the inventive concepts are not limited by the accompanying drawings, but includes all the modifications, equivalents, and substitutions included in the spirit and the scope of the inventive concepts.

Terms including ordinal numbers such as “first”, “second”, etc., may be used to describe various components, but the components are not to be construed as being limited to the terms. The terms are used to distinguish one component from another component.

It is to be understood that when one element is referred to as being “connected to” or “coupled to” another element, it may be connected directly to or coupled directly to another element or be connected to or coupled to another element, having the other element intervening therebetween. On the other hand, it should be understood that when one element is referred to as being “connected directly to” or “coupled directly to” another element, it may be connected to or coupled to another element without the other element interposed therebetween.

Singular expressions are intended to include plural expressions unless the context clearly represents otherwise.

It will be further understood that terms “include”, “have”, or the like used in the present specification specify the presence of features, numerals, steps, operations, components, parts mentioned in the present specification, or combinations thereof, but do not preclude the presence or addition of one or more other features, numerals, steps, operations, components, parts, or combinations thereof.

The inventive concepts are directed to providing a combinatorial optimization system capable of generating an optimized solution to a combinatorial optimization (CO) problem, its control method, and a learning method of a combinatorial optimization system. More specifically, the inventive concepts are directed to providing a combinatorial optimization model capable of generating an optimized solution that minimizes cost while satisfying constraints of a combinatorial optimization problem instance.

The combinatorial optimization is a branch of optimization, and may be a field that finds a solution that satisfies an optimal objective value from a finite set of discrete candidate solutions.

The combinatorial optimization problems have various characteristics. For example, the set of solutions to a combinatorial optimization problem may be discrete (e.g., path, set, arrangement, matching, etc.). In addition, a solution space may grow exponentially as a problem size increases. In addition, most combinatorial optimization problems may be classified into NP-hard or NP-complete. In addition, since the search target is limited to a subspace that satisfies the constraints rather than the entire solution space, it may be difficult to find a valid solution itself.

For example, the combinatorial optimization problem may be understood as involving problems that satisfy various conditions. The solution space may be discrete and composed of nodes and edges as basic units. In addition, constraints may be set (or provided) for problem instances, and the optimization of the objective function may be performed in a way that satisfies the constraints. In addition, the objective function may be quantified as cost or value and aims for minimization or maximization. In addition, there may be cases where the solution space is so large that brute-force search is practically impossible.

Furthermore, in the combinatorial optimization problem, the solution space may be the set of all possible candidate solutions. In this case, when constraints are set, the actual search target may be limited not to the entire solution space, but to a subset of valid solutions that satisfy the constraints. The combinatorial optimization system according to the inventive concepts may search for optimized solutions that achieve the objective function optimization within the valid solution space that reflects constraints.

Such a combinatorial optimization problem is a problem of finding an optimized solution within a discrete solution space under constraints, and may include various types of problems such as path optimization, set selection, and graph structure optimization. For example, a traveling salesman problem, which is one of the combinatorial optimization problems, is a problem of determining the order of visiting cities so that a salesman visits each city exactly once while minimizing a total travel distance, when the locations of the cities that the salesman should visit are given. In the traveling salesman problem, an instance may represent an ‘n’ number of cities to be visited. A solution to the instance may be represented as a matrix (binary matrix), and each element of the matrix may refer to whether travel occurs between specific cities. In the entire solution space, the valid solution space may be a set of valid TSP paths in which each city is visited exactly once. In this case, the objective function represents the total length of the given path, which should be minimized. That is, the objective value of the traveling salesman problem may be the total travel distance between cities.

For another example, in a maximum independent set (MIS) problem, an instance represents a graph that may include a set of vertices (or nodes) and a set of edges (lines). The solution space indicates whether each vertex is included in the solution set. To satisfy the independence condition, the solutions should not simultaneously include vertices connected by edges. In this case, the objective function represents the total number of selected vertices, which should be maximized.

To this end, embodiments of the invention provide a method and system for effectively searching for an optimized solution, which satisfies constraints and optimizes an objective function for the combinatorial optimization problem, using a combinatorial optimization model trained through supervised learning and reinforcement learning. The optimized solution may be referred to as the optimal solution, but is hereinafter referred to as the optimized solution.

The combinatorial optimization system, its control method, and the learning method of a combinatorial optimization system according to embodiments of the invention may be effectively applied to various industries and services. For example, the inventive concepts may be applied to and utilized in systems (or applications, software, websites, programs, etc.) based on at least one of an artificial neural network, a generative AI model (e.g., a diffusion model), or an AI algorithm (e.g., a shortest path search algorithm, an algorithm related to combinatorial optimization, etc.).

The industries and services to which the inventive concepts may be applied may be various. The inventive concepts may be applied and utilized in studies to solve the traveling salesman problem, the vehicle routing problem, the maximum independent set problem, etc. For example, the inventive concepts may be applied and utilized in various fields and services, such as operation research, logistics optimization, manufacturing and production planning, semiconductor and chip design automation (e.g., PCB design, circuit design, etc.), communications and network design, financial services, games, elevators, security (or patrol), and hospitals.

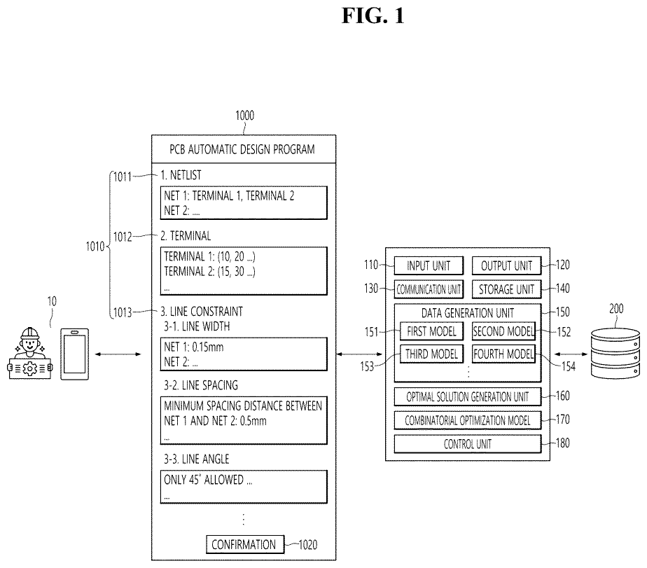

In this regard, industries and services to which the combinatorial optimization method and system according to the inventive concepts may be applied will be briefly described with reference to FIG. 1. The combinatorial optimization system according to FIG. 1 may include the combinatorial optimization model (or generative model), and may use the combinatorial optimization model to generate an optimized solution (i.e., an optimized wiring path) that satisfies various constraints (e.g., no-line zones, line width and spacing, line angle, multi-layer line, etc.) required for PCB design or search for a shortest path for wiring terminals at a minimum cost (or expense) based on PCB data input by a user.

In an embodiment, the control unit 180 may receive PCB data 1010 including a netlist 1011, terminal information 1012, and constraint information 1013 based on the selection of a graphic object (e.g., CONFIRMATION 1020) linked to a user input reception function of a service page 1000 from the user terminal 10.

A net is a path that should be connected to transmit signals or supply power in a circuit, and may refer to a group of terminals (electrical contacts) that require electrical connection or exchange signals. For example, when a first terminal and a second terminal should be connected by wiring, the first terminal and the second terminal may be understood as belonging to the same net.

The netlist 1011 may include a list (or set) of terminals that should be electrically connected. More specifically, the netlist 1011 may include information defining the connection relationships between the terminals that should be electrically connected. The terminals defined in the netlist 1011 may be key nodes that should be electrically connected on the PCB. For example, a user (or engineer) may group terminals, which should be electrically connected among a plurality of terminals, into a single net, and input the grouped net group information into the netlist 1011. In this case, “Net 1: Terminal 1, Terminal 2” input to the netlist 1011 may be interpreted as meaning “The first terminal should be connected to the second terminal”.

Accordingly, the netlist 1011 included in the PCB data 1010 may include net group information, which groups the terminals that should be electrically connected among the plurality of terminals and groups the terminals into individual nets. That is, the net group information included in the netlist 1011 may be understood as information indicating which terminals are grouped into a single net and what connections should be made between the terminals included in each net.

In addition, the plurality of terminals included in the terminal information 1012 may represent electrical connection points (pins or nodes of electronic components) where actual wiring should be performed. Here, the term “electrical connection point” refers to an electrical contact (starting point and ending point) where a line begins or ends, and the terminal may refer to an electrical contact where a line begins or ends. The electrical contact may serve to form a path for an electrical signal to travel to other components or circuits within a circuit. For example, the electrical contact may serve to i) allow current to be supplied to an electronic device through the contact, ii) allow power to be supplied from a contact of a battery terminal (positive and negative), iii) provide a physical connection between electronic components to allow signals or power to flow, or iv) connect pins of an IC chip to traces in a PCB design.

The terminal is a point on the PCB where electronic components, such as resistors or transistors, are mounted, and may be represented as a component pin or an electrical node on the PCB. Examples of the terminal may include a specific pin of an integrated circuit (IC) chip, a contact of a connector, an end point of a PCB (or circuit) trace, etc. That is, the plurality of terminals may correspond to the electrical contacts where the line begins or ends on the PCB defined by the PCB data 1010. In this case, the PCB data 1010 may include coordinate information for each of the plurality of terminals. In this case, when the PCB to be designed has a multi-layer structure, the PCB data 1010 may further include information on a layer where each terminal is located.

Furthermore, the line constraints 1013 are constraints that should be observed in the PCB wiring, and may include various constraints essential to ensure the performance and reliability of the circuit. For example, the line constraints include at least one of i) line width, ii) line spacing, and iii) no-line area (or zone), iv) 45° line, v) line length constraint.

The line width may refer to a thickness (or width) of a line. For example, it is necessary to maintain a constant line width in order to allow current to flow safely on the PCB.

The line spacing may refer to a minimum distance that should be maintained between different nets (lines). For example, when a spacing between lines is too close, signal interference or short circuit may occur. As a result, to prevent the signal interference or short circuit, there is a need to maintain a safe distance (or minimum distance) between different lines.

The no-line area may refer to an area where lines may not be arranged (or connected) (i.e., area where lines may not be drawn). For example, when a specific area is intended for mounting of electronic components or has electromagnetic interference or other significant constraints, the specific area may be designated as the no-line area.

The 45° line may refer to a constraint that lines should be connected at a 45° angle rather than a right angle (90°). For example, the 45° line is designed to reduce signal reflection and smoothly transmit signals. Specifically, lines may be designed (or connected) at a 45° angle for high-speed or sensitive signals.

The line length constraint may refer to a constraint that limits a maximum length of a path connecting terminals. The line length constraint is very important in high-frequency devices. This is because, when a signal propagates along a lengthy line, signal amplitude may be reduced and at the same time, noise is amplified, thereby potentially degrading the circuit performance.

The PCB data 1010 may be data related to the combinatorial optimization problem instance. The objective of the PCB design is to connect all terminals included in the netlist 1011 while satisfying all the constraints described above.

In this case, the control unit 180 may use the trained combinatorial optimization model 170 to perform inference for the PCB design which is one of the combinatorial optimization problems. The trained combinatorial optimization model 170 may generate an optimized solution (or optimized path) that wires terminals (nodes) defined in the netlist at a minimum cost while satisfying constraints based on instances input by the user, and provide the generated optimized solution to the user terminal 10.

The combinatorial optimization system according to the inventive concepts includes a combinatorial optimization model, and the inventive concepts aim to provide a combinatorial optimization model that may be universally utilized in combinatorial optimization problems of various scales.

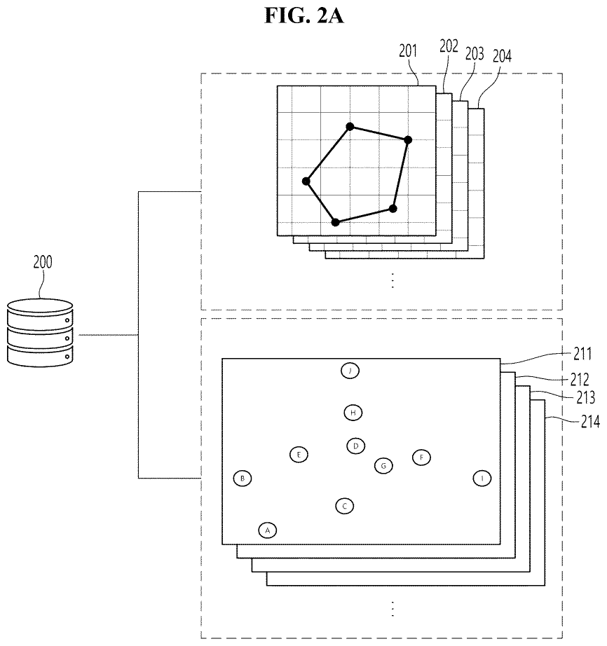

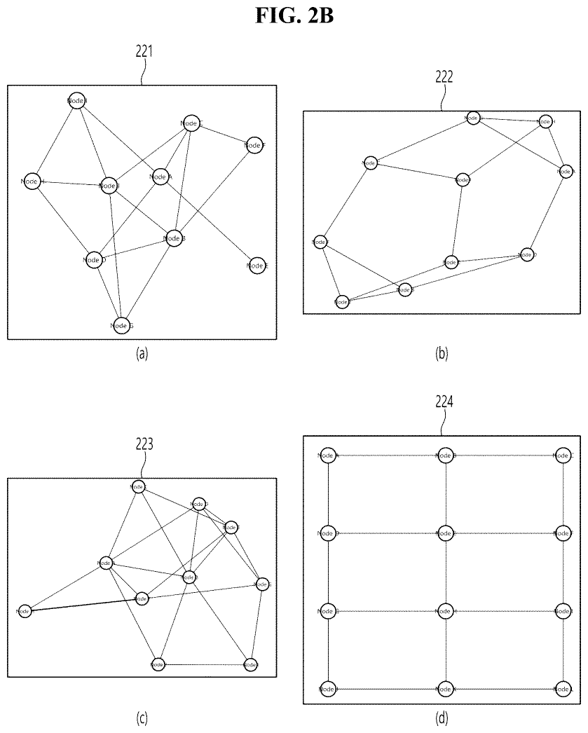

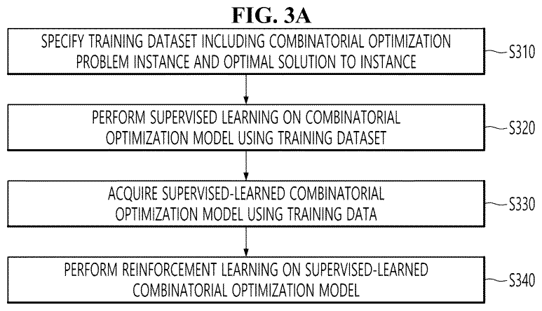

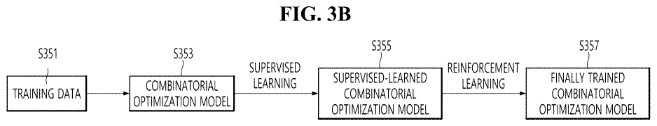

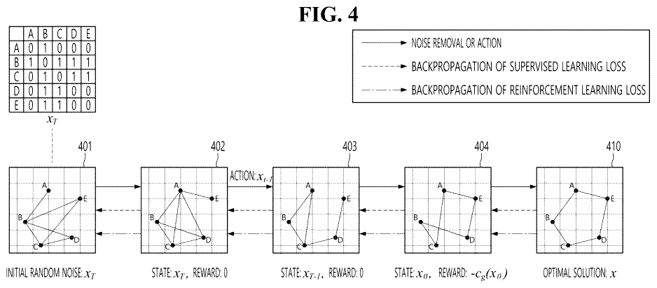

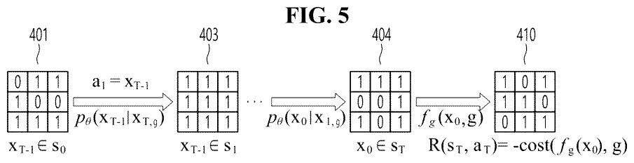

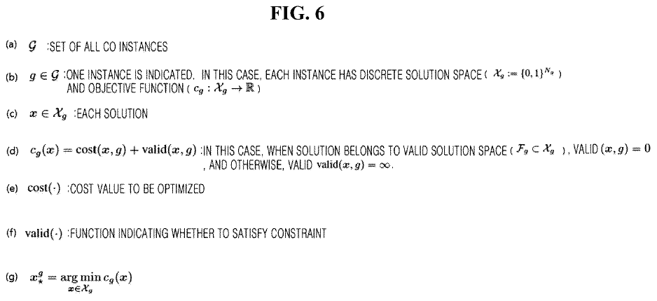

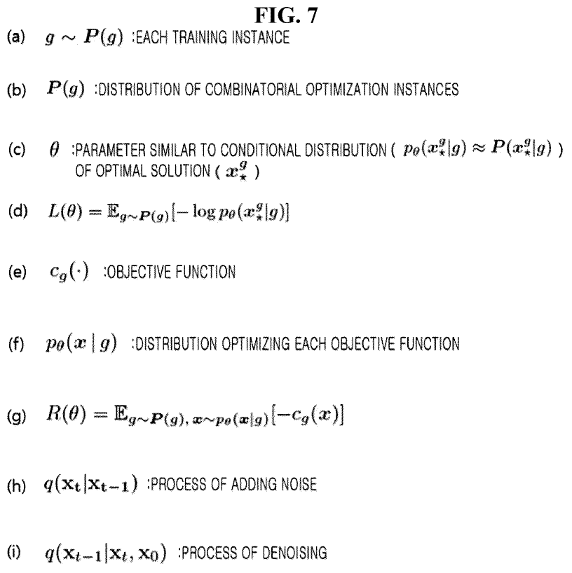

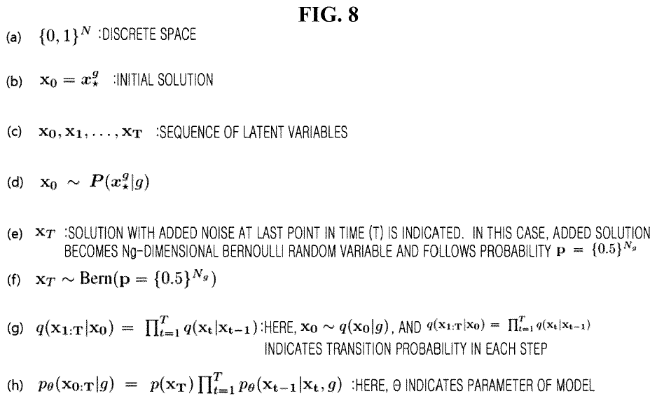

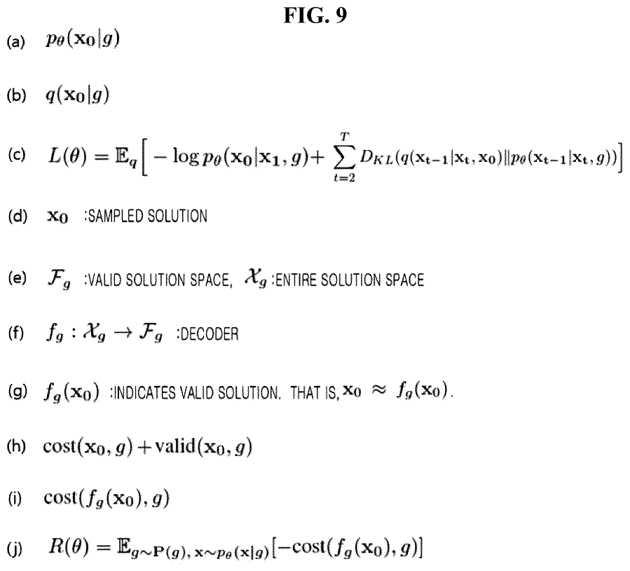

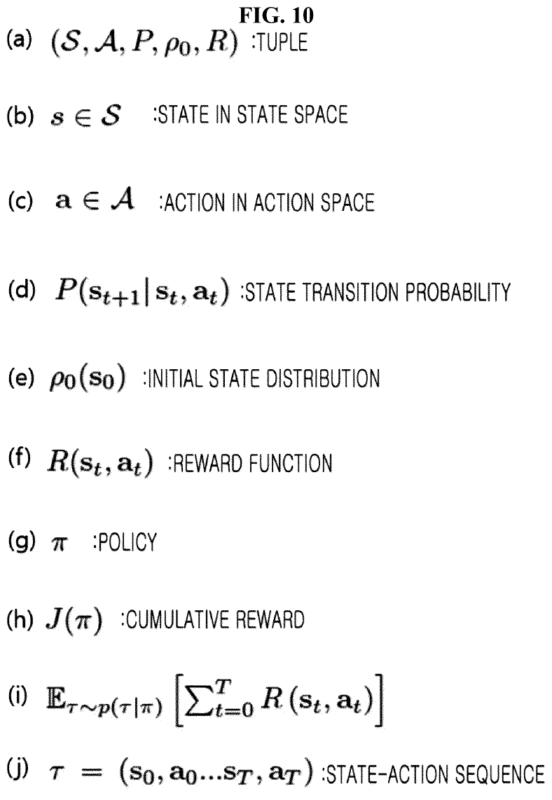

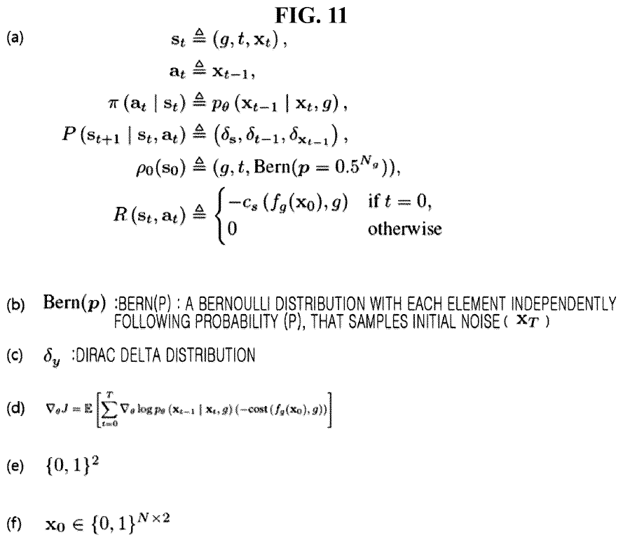

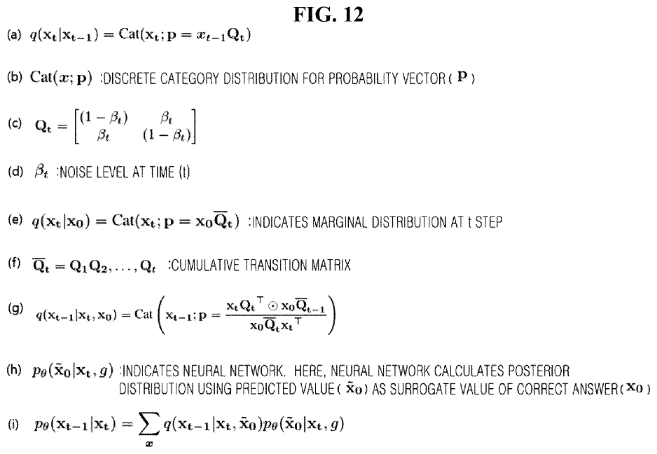

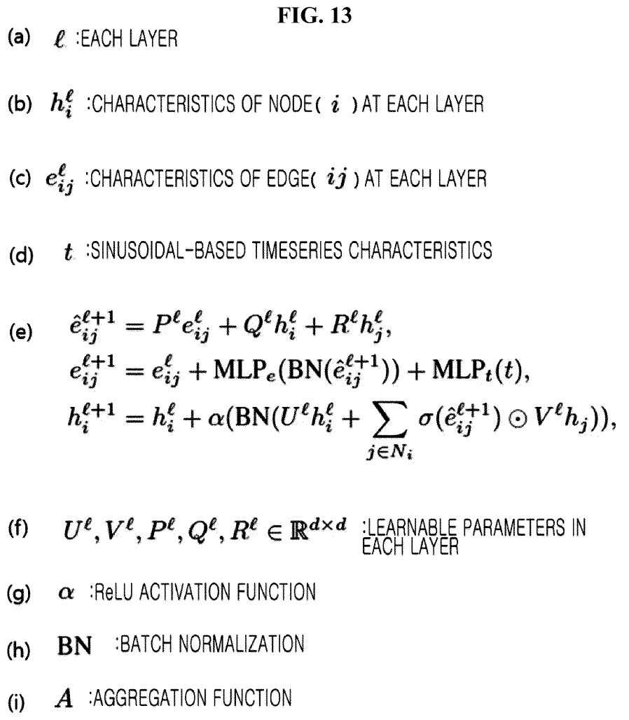

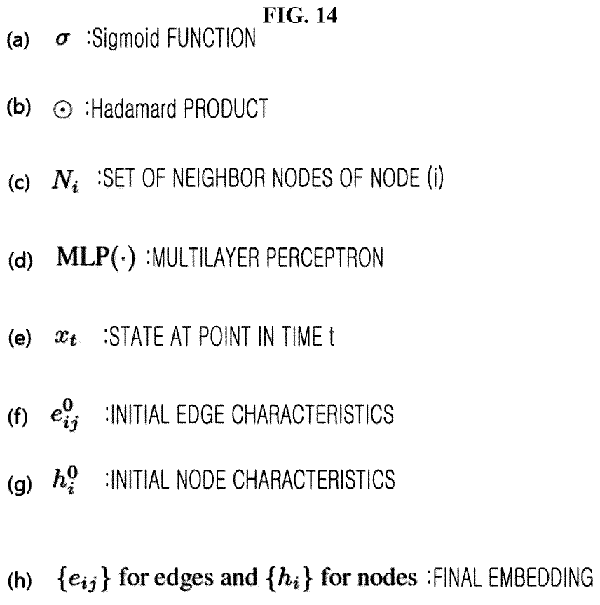

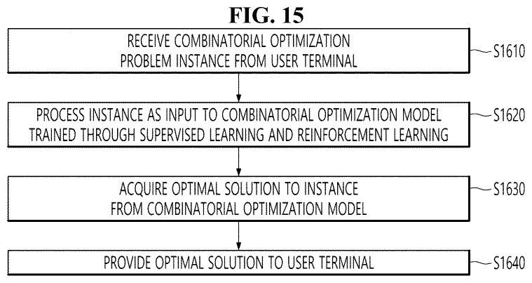

Hereinafter, embodiments of the invention will be examined in more detail with the accompanying drawings. FIG. 1 is a conceptual diagram for describing a combinatorial optimization system according to embodiments of the invention, and FIGS. 2A and 2B are conceptual diagrams for describing a training dataset according to embodiments of the invention. FIGS. 3A and 3B are flowcharts for describing a learning method of a combinatorial optimization system according to embodiments of the invention, and FIGS. 4 to 14 are conceptual diagrams for describing the learning method of a combinatorial optimization system according to embodiments of the invention. Furthermore, FIG. 15 is a flowchart for describing a control method of a combinatorial optimization system according to embodiments of the invention.

As illustrated in FIG. 1, a combinatorial optimization system 100 according to embodiments of the invention may include at least one of an input unit 110, an output unit 120, a communication unit 130, a storage unit 140, a data generation unit 150, an optimal solution generation unit 160, a combinatorial optimization model 170, and a control unit 180.

The combinatorial optimization system 100 according to embodiments of the invention may include at least one processor and at least one memory including computer program code. In this case, the storage unit 140 may function as the memory. In the inventive concepts, the memory and the program code may cooperate with the processor to perform a series of processes described below.

Although not illustrated, the combinatorial optimization system 100 according to embodiments of the invention may include one or more processors, in which the processors may include one or more general-purpose processors and/or one or more special-purpose processors (e.g., a digital signal processor, a tensor processing unit (“TPU”), a graphics processing unit (“GPU”), a neural network processing unit (“NPU”), an application-specific integrated circuit (“ASIC”) or semiconductor device, a field programmable gate array (“FPGA”), and a quantum processing device (or quantum processor (“QPU”), etc). One or more processors may be configured to execute instructions stored (or included) in the storage unit 140, computer-readable instructions, and/or other instructions described herein. The combinatorial optimization method and system according to embodiments of the invention may perform data processing to be described below through cooperation between a memory and at least one processor. The processor may perform a series of operations and data processing using data and information stored in the memory. In this case, the memory may be a component of the storage unit 140.

In addition, the combinatorial optimization system 100 according to embodiments of the invention may perform data processing and calculation processes using a quantum gate, quantum entanglement, and quantum superposition states by considering implementation in a quantum computer environment. For example, embodiments of the invention may perform a qubit-based parallel operation, and such a quantum operation may operate complementarily with existing classical computers.

The quantum computer may include a high-speed data processing device utilizing the qubit-based parallel operation and the quantum entanglement, and enables hardware-based computation optimization using the FPGA and ASIC. In addition, the quantum computer may utilize a quantum processor capable of the qubit-based parallel operation, and improve data processing efficiency through a hybrid structure with the existing classical computers.

The input unit 110 serves as a means for data input, and may be implemented in various forms. For example, the input unit 110 may be configured to receive the user input. The input unit 110 may be configured to receive the user input from the user terminal 10. Here, “receiving the input” may mean receiving an input signal (or “selection signal”) corresponding to the user input based on the fact that the input is made by the user through the configuration of the input unit provided in the user terminal 10.

In addition, in embodiments of the invention, the input unit 110 does not necessarily refer to a hardware means, but may be understood as a channel for receiving input from a user.

The input unit 110 may also be referred to as a user interface module. The input unit 110 may include a touch screen, a computer mouse, a keyboard, a keypad, a touch pad, a trackball, a joystick, a voice recognition module, or other similar devices. However, in embodiments of the invention, the type of the input unit 110 is not limited.

Here, the user input may include documents, text, images (or videos), speech, etc. In this case, the combinatorial optimization system 100 may further include a module that converts speech into text.

Next, the output unit 120 may output information through components (e.g., a display unit, a touch screen, a speaker, etc.) of the output unit provided in the user terminal 10 linked to the combinatorial optimization system 100 according to embodiments of the invention. For example, the output unit 120 may output a page (or service page, 1000) linked to the combinatorial optimization system 100 according to embodiments of the invention on the display unit of the user terminal 10. In addition, the output unit 120 does not necessarily refer to hardware means, but may be understood as a channel for outputting results to the user.

Next, the communication unit 130 may be connected to the user terminal 10, a server (e.g., a central server, an external server, etc.), a device, and at least one network via a wireless or wired network, and may be configured to receive or transmit overall data and information necessary for the operation of the combinatorial optimization system 100 according to embodiments of the invention.

Here, the user terminal 10 may include at least one of a mobile phone, a smart phone, a notebook computer, a laptop computer, a slate PC, a tablet PC, an ultrabook, a desktop computer, a digital broadcasting terminal, a personal digital assistant (“PDA”), a portable multimedia player (“PMP”), a navigation device, or a wearable device (e.g., a smartwatch, smart glass, or a head-mounted display (“HMD”)).

Furthermore, the communication unit 130 may support various communication schemes depending on communication standards of a communicating device.

For example, the communication unit 130 may be configured to communicate with a communication target using at least one of wireless LAN (“WLAN”), wireless-fidelity (“Wi-Fi”), wireless fidelity (“Wi-Fi”) direct, digital living network alliance (“DLNA”), wireless broadband (“WiBro”), world interoperability for microwave access (“WiMAX”), high speed downlink packet access (“HSDPA”), high speed uplink packet access (“HSUPA”), long term evolution (“LTE”), long term evolution-advanced (“LTE-A”), 5th generation (“5G”) mobile telecommunication, Bluetooth (“Bluetooth™”), radio frequency identification (“RFID”), infrared data association (“IrDA”), ultra-wideband (“UWB”), ZigBee, near field communication (“NFC”), Wi-Fi direct, and wireless universal serial bus (“wireless USB”) technologies.

Next, the storage unit 140 (or memory) serves to store various data related to embodiments of the invention and may include one or more non-transitory computer-readable storage media that may be read and/or accessed by at least one of the one or more processors.

One or more computer-readable storage media may include volatile and/or non-volatile storage components, such as optical, magnetic, organic, or other memory or disk storage devices. In some examples, the storage unit 140 may be implemented using a single physical device (e.g., a single optical, magnetic, organic, or other memory, or disk storage device), while, in other examples, the storage unit 140 may be implemented using two or more physical devices.

The storage unit 140 may include computer-readable instructions and additional data. The storage unit 140 may include storage necessary to perform at least some of the methods, scenarios, and techniques described herein and/or at least some of the functions of the devices and networks.

Furthermore, at least a portion of the storage unit 140 may be cloud storage or a cloud server. The storage unit 140 may store data corresponding to the user input received from the input unit 110 and at least a portion of the training data (or training dataset 200).

That is, the storage unit 140 may be sufficient as long as it has a space storing information necessary for the operation of the combinatorial optimization system 100 according to embodiments of the invention, and it may be understood that there are no physical space constraints.

Furthermore, the storage unit 140 may store a computer program including computer program instructions. Furthermore, the storage unit 140 may store a computer program including computer program instructions that control the operation of the system 100 or the operation of the control unit 180 when the computer program instructions are loaded onto the processor of the system 100.

Next, the data generation unit 150 may be configured to generate data (instances) required for training the combinatorial optimization model 170 according to embodiments of the invention. The data generation unit 150 may serve to generate various types of graphs including (or composed or consisting of) nodes and edges. To this end, the data generation unit 150 may include at least one model that generates different types of graphs composed of nodes and edges. For example, the data generation unit 150 may include at least one of a first model 151, a second model 152, a third model 153, and a fourth model 154. In embodiments of the invention, the data generation unit 150 may also be referred to as a “graph generation unit”.

The first model 151 may also be referred to as an “Erdos-Renyi (ER) model” and may be a model that generates a first type of graph among a plurality of preset graph types. For example, as illustrated in (a) of FIG. 2B, the first model 151 may generate a first type of graph 221 by connecting edges at the same probability for all pairs of nodes in the graph. The first type of graph 221 may include an ER graph. This first type of graph 221 is a type of random graph, and the probability that an edge exists between any pair of nodes may be “r”. In order to generate the first type of graph 221, the data generation unit 150 may sample the edge generation probability from a uniform distribution and use the sampled value as a parameter of the first model 151.

The second model 152 may also be referred to as a “Random-Regular (RR) model” and may be a model that generates a second type of graph among the plurality of preset graph types. For example, as illustrated in (b) of FIG. 2B, the second model 152 may generate a second type of graph 222 in which all nodes of the graph have the same degree. The second type of graph 222 may include a random regular (RR) graph. This second type of graph 222 is a type of random graph and may have the characteristic that all nodes have the same degree. The data generation unit 150 configures all nodes to have the same number of neighbors to generate the second type of graph 222. In this case, the number of neighbors is sampled from “Uniform ((3,4,5))”, which is a uniform (or equal) distribution of degrees of the graph, and the sampled degree value may be used as a parameter of the second model 152.

The third model 153 may also be referred to as a “Watts-Strogatz (WS) model“ and may be a model that generates a third type of graph among the plurality of preset graph types. For example, as illustrated in (c) of FIG. 2B, the third model 153 may generate a third type of graph 223 having small-world properties that include both minimum path length and high clustering. The third type of graph 223 may include a WS graph. The third type of graph 223 is a graph generated to simulate (or imitate) small-world networks, and may provide a balance between regular and random connections to reproduce a small-world effect and clustering observed in the real world. To generate the third type of graph 223, the third model 153 may sample an average node degree from ”Uniform((3,4,5,6))”, which is a uniform distribution, and sample the rewiring probability from “Uniform(0, 1)”.

The fourth model 154 may also referred to as a “grid model”, and may be a model that generates a fourth type of graph among the plurality of preset graph types. For example, as illustrated in (d) of FIG. 2B, the fourth model 154 may generate a fourth type of graph 224 in which all nodes are arranged in a lattice form. The fourth type of graph 224 may include a grid or lattice graph. The fourth type of graph 224 may be understood as a graph having a structure in which nodes and edges are arranged in a lattice form. When generating the fourth type of graph 224, the fourth model 154 may sample a combination of width and height for the input number n of nodes and set the combination of width and height to be a product of n. For example, when n =20, the fourth model 154 may generate a graph by sampling from a combination such as 4×5 or 5×4, and ensuring that one dimension is greater than a preset value (e.g., 4). In this case, unlike other graph types, for the fourth type of graph-based instance, the edge cost may be set to a specific fixed value (e.g., 1). That is, among the plurality of graph types 221, 222, 223, and 224, the fourth type of graph 224 generated from the fourth model 154 may be generated with the cost of the edges fixed. This may be understood as intended to ensure that the instance has properties similar to those found (or discovered) in a Euclidean space.

However, in embodiments of the invention, the model included in the data generation unit 150 (or the combinatorial optimization system 100) for generating the plurality of graph types are not necessarily limited to the above-described model, and may further include other models in addition to the first model 151, the second model 152, the third model 153, and the fourth model 154 described above. The models applied in the inventive concepts may be variously changed and/or set to one or more depending on the purpose of use or situation (or case).

Next, the optimal solution generation unit 160 (or optimal answer generation unit, optimal solution calculation unit, optimal answer calculation unit, etc.) may be configured to generate (or calculate, derive, etc.) an optimized solution to an instance for a Steiner tree problem (or combinatorial optimization problem).

The optimal solution generation unit 160 may include a mixed-integer linear programming (“MILP”)-based SCIP-Jack solver for calculating an optimized solution. The mixed-integer linear programming is an extension of linear programming and may be understood as a scheme for modeling and solving problems by combining integer and real variables. The optimal solution generation unit 160 may calculate the optimized cost of the combinatorial optimization problem instance generated based on a graph and derive the optimized solution based on the calculated result. In addition, the optimal solution generation unit 160 may include at least one of a Concorde solver (e.g., a “Concorde TSP solver”) and an LKH-3 heuristic solver.

At least one of the reference solutions to the training instances included in the training dataset 200 according to embodiments of the invention may include the optimized solution generated by the optimal solution generation unit 160.

In an embodiment, as illustrated in FIG. 2A, the plurality of reference solutions 201, 202, 203, and 204 for the plurality of instances included in the training dataset 200 may be the optimized solution generated from the optimal solution generation unit 160. Therefore, the reference solution for training of models may be referred to as the “optimized solution”, the “optimal solution”, or the “correct solution”, but is hereinafter referred to as the “reference solution” or the “optimized solution”.

The optimal solution generation unit 160 may generate the reference solutions 201, 202, 203, and 204 for each of the plurality of instances using at least one of the Concorde solver and the LKH-3 heuristic solver.

In another embodiment, a plurality of reference solutions 211, 212, 213, and 214 for the plurality of instances included in the training dataset 200 may be the reference solution generated from the optimal solution generation unit 160. In this case, the plurality of instances may be related to instances generated through the plurality of graphs 221, 222, 223, and 224 having different types generated from the data generation unit 150. In this case, the optimal solution generation unit 160 may use the SCIP-Jack solver to generate the reference solutions 211, 212, 213, and 214 for each instance generated using the plurality of graphs 221, 222, 223, and 224.

The combinatorial optimization model 170 may serve to calculate the combinatorial optimization problem instance and the reference solution corresponding to the instance.

In embodiments of the invention, the combinatorial optimization model 170 is a diffusion-based generative model (e.g., a diffusion model), and may learn the distribution of the high-quality solutions in the solution space of the combinatorial optimization problem and generate solutions to new problem instances based on the learned distribution. In this case, the combinatorial optimization model 170 may also be understood as a solver that solves the combinatorial optimization problem. In embodiments of the invention, the combinatorial optimization model 170 may also be referred to as a “generative model”, a “DIFUSCO model”, a “CADO model”, a “diffusion model”, a “combinatorial optimization solver”, or the like.

In embodiments of the invention, an anisotropic graph neural network (GNN), to which edge gating is applied, may be used as a backbone network of the combinatorial optimization model 170. The combinatorial optimization model 170 may consider node and edge characteristics in each layer (see (a) to (c) of FIG. 13). In addition, the sinusoidal-based time series characteristics corresponding to the restoration timestep may be represented as illustrated in (d) of FIG. 13. Subsequently, the characteristics are transferred to the next layer via an anisotropic message transmission mechanism. This may be represented as illustrated in (e) of FIG. 13.

Here, learnable parameters in each layer are represented as in (f) of FIG. 13, and a ReLU activation function may be represented as in (g) of FIG. 13. In addition, batch normalization may be represented as in (h) of FIG. 13, and an aggregation function implemented through SUM polling may be represented as in (i) of FIG. 13. In addition, a sigmoid function may be represented as in (a) of FIG. 14, and a Hadamard product may be represented as in (b) of FIG. 14. Furthermore, the set of neighbor nodes of node (i) may be represented as in (c) of FIG. 14, and the multilayer perceptron may be represented as in (d) of FIG. 14.

In an embodiment, for the traveling salesman problem, the initial edge characteristics are derived from the state at point in time t (see (e) and (f) of FIG. 14), and the initial node characteristics may be initialized with sinusoidal characteristics of nodes (see (g) of FIG. 14). In contrast, for the maximum independent set problem, edge characteristics may be initialized to 0, and node characteristics may be set to binary values corresponding to the state at point in time t. Then, a classification or regression head is applied. For classification, two neurons may be used for each node and edge, and for regression, one neuron may be used. Finally, the final embedding for the state at the point in time t (see (h) of FIG. 14) may be used according to the discrete and continuous diffusion models, respectively.

The combinatorial optimization model 170 may be trained through supervised learning (SL) using the training dataset 200 including solutions to the combinatorial optimization problems to generate solutions similar in type to the training dataset 200. In this case, in embodiments of the invention, the supervised-learned combinatorial optimization model may be additionally trained through the reinforcement learning (RL).

Specific content of the training of the combinatorial optimization model 170 will be described later.

Next, the control unit 180 may serve to control the overall operation of the combinatorial optimization system 100 according to embodiments of the invention. The control unit 180 may process signals, data, information, etc., input or output through the components of the combinatorial optimization system 100 described above, or perform a series of data processing to provide or process appropriate information and functions to a user. The control unit 180 may be physically implemented by the processor described above.

Embodiments of the invention are directed to providing a combinatorial optimization system capable of generating an optimized solution to a combinatorial optimization (CO) problem, its control method, and a learning method of a combinatorial optimization system. More specifically, embodiments of the invention provide the combinatorial optimization model capable of generating an optimized solution that minimizes cost while satisfying the constraints of the combinatorial optimization problem instance. Hereinafter, the learning method of a combinatorial optimization model will be described in more detail.

Embodiments of the invention include a process (S310) of specifying a training dataset including a combinatorial optimization problem instance and at least one reference solution corresponding to the instance, and a process (S320) of performing supervised learning on a combinatorial optimization model using the training dataset (see FIG. 3).

The control unit 180 may specify the training dataset to be used for training the combinatorial optimization model 170. The criteria (or scheme) for specifying the training dataset in embodiments of the invention may be various. For example, the control unit 180 may specify the training dataset 200 stored in the storage unit 140 (or memory) as the training dataset 200 to be used for training the combinatorial optimization model 170, or may specify data based on the user input from the user terminal 10 as the training data.

In an embodiment, the control unit 180 may specify the training dataset 200 stored in the storage unit 140 (or memory) as the training data to be used for training the combinatorial optimization model. As described above, the training dataset 200 may be configured to include at least one instance of the combinatorial optimization problem and an reference solution corresponding to the instance.

For example, the training dataset 200 may include a plurality of instances and reference solutions 201, 202, 203, and 204 to each of the plurality of instances. In this case, the plurality of instances and reference solutions included in the training dataset 200 may be collected from various sources (e.g., web crawling, a server linked to the combinatorial optimization system 100, an external server, etc.) (see FIG. 2A).

For another example, at least some of the plurality of instances and their corresponding reference solutions included in the training dataset 200 may include instances generated by the data generation unit 150 and reference solutions generated by the optimal solution generation unit 160 for those instances. The reference solutions are defined as optimized solutions used for traning. In this case, the instances generated by the data generation unit 150 may be associated with the plurality of graphs 221, 222, 223, and 224 of different types.

In this case, the instances may be associated with instances generated using a plurality of graphs (221, 222, 223, 224) having different types. The plurality of graphs (221, 222, 223, 224) having different types may be generated by the data generation unit 150.

In this case, the optimal solution generation unit 160 may generate the reference solutions 211, 212, 213, and 214 to each of the generated instances using the plurality of graphs 221, 222, 223, and 224 (see FIGS. 2A and 2B).

The control unit 180 may perform the supervised learning on the combinatorial optimization model 170 using the specified training dataset 200.

Regarding the combinatorial optimization problem, the set of all instances included in the training dataset 200 may be represented as in (a) of FIG. 6, and one specific instance may be represented as in (b) of FIG. 6. Each instance (g) included in the training dataset 200 includes a discrete solution space and an objective function (see (b) of FIG. 6), which may be defined for each solution (see (c) of FIG. 6), as in (d) of FIG. 6. Here, “cost” represents a cost value to be optimized (see (e) of FIG. 6), and “valid” may be a function indicating whether the constraints are satisfied (see (f) of FIG. 6). That is, when a solution (x) belongs to the valid solution space, the value of the function indicating whether the constraints are satisfied is 0, and when the solution does not belong to the valid solution space, the value of the function may be infinite.

The objective of the combinatorial optimization is to calculate an optimized solution to an instance (g) input (or given) to the combinatorial optimization model 170. The optimized solution to the combinatorial optimization problem instance may be represented as illustrated in (g) of FIG. 6. In embodiments of the invention, the optimal solution may also be referred to as an “optimal solution”, “optimal answer”, “correct solution”, “high-quality solution”, “correct answer”, “high-quality answer”, etc.

For the supervised learning on the combinatorial optimization model 170, the control unit 180 may input a training dataset 200 to the combinatorial optimization model 170 (S351, see FIG. 3B). The control unit 180 may process at least one instance included in the training dataset 200 and an reference solution to the instance as inputs to the combinatorial optimization model 170. In this case, the instance input to the combinatorial optimization model 170 may be input in the form of a binary matrix (see FIG. 4). The binary matrix may be converted to correspond to each of plurality of instances and included in the training dataset 200, or the control unit 180 itself may convert a specific instance into the binary matrix and input the binary matrix to the combinatorial optimization model 170.

In the supervised learning process (or step), the combinatorial optimization model 170 may assume the availability of the reference solutions to each instance (or training instance, see (a) of FIG. 7) included in the training dataset 200. In this case, the distribution of the combinatorial optimization instances may be represented as illustrated in (b) of FIG. 7.

The objective of the supervised learning is to specify (or determine) parameters for the combinatorial optimization model 170 to simulate (or approximate) the conditional distribution of the optimal solutions to the training instances. The combinatorial optimization model 170 maximizes the likelihood (or probability) through the objective function, which may be represented as illustrated in (d) of FIG. 7.

Here, the conditional distribution may refer to a distribution (or probability distribution) from which the optimized solution is generated (or sampled, calculated, etc.) when the instance related to the combinatorial optimization problem is given. This may mean training (or performing learning on) the parameters of the combinatorial optimization model 170 so that the distribution (or probability distribution, generative distribution, sampling distribution, predictive distribution, etc.) of the combinatorial optimization model 170 approaches (or becomes similar to) the actual data distribution, i.e., the distribution of the optimized solutions corresponding to the correct answer.

That is, the control unit 180 may maximize the probability distribution of the optimized solution generated from the combinatorial optimization model 170. For another example, the control unit 180 may minimize the difference between the probability distribution of the optimized solution generated from the combinatorial optimization model 170 and the distribution of the reference solutions included in the training dataset 200.

The control unit 180 may perform the supervised learning on the combinatorial optimization model to approximate (or simulate) the conditional distribution of the reference solutions to the instances included in the training dataset 200 (S353, see FIG. 3B). More specifically, the control unit 180 may perform learning of or train (or adjust) the parameters of the combinatorial optimization model 170 so that the combinatorial optimization model approximate the conditional distribution (or conditional probability distribution) of the optimized solutions to the input instances.

As described above, the combinatorial optimization model 170 according to embodiments of the invention may include a diffusion-based generative model. The control unit 180 may train the combinatorial optimization model through a diffusion process.

The diffusion process may include the forward noising process and the backward denoising process. In the diffusion process, the control unit 180 may train the parameters of the combinatorial optimization model 170 so that the probability distribution of the solution sampled (or generated, predicted) by the model approximates the conditional distribution of the optimized solution. The parameters of the combinatorial optimization model 170 may be adjusted to well approximate the distribution of the optimized solution. In the diffusion process (e.g., the backward denoising process), the control unit 180 may train the combinatorial optimization model 170 in a way in which the combinatorial optimization model 170 well approximates the distribution of the optimized solution at each time step (or stage). That is, in the diffusion process, the combinatorial optimization model 170 may gradually perform the restoration from the solution to which noise has been added, and may be understood as adjusting the probability distribution at each step to be closer to that of the optimized solution (i.e., as minimizing the difference between the distribution of the optimized solution and the distribution of the solution restored by the model) in order to ultimately generate the solution similar to the optimized solution.

Hereinafter, the diffusion process performed in the supervised learning process will be described in more detail.

As illustrated in FIGS. 4 and 5, a specific instance may be input to the combinatorial optimization model 170 in the form of the binary matrix. In the binary matrix, each row and column refers to a node, and the value may indicate whether the node is connected or not (e.g., 1=connected, 0=not connected).

Since the optimized solution 410 is contained in the discrete space (see (a) of FIG. 8), the forward noising process and the backward denoising process may be performed in the same ideal space. Here, the forward noising process may be represented as in (h) of FIG. 7, and the backward denoising process may be represented as in (i) of FIG. 7.

The combinatorial optimization model 170 gradually adds noise to the optimized solution through the forward noising process, thereby generating (or sampling) solutions with added noise. More specifically, the combinatorial optimization model 170 may generate sequences (e.g., 401, 402, and 403, etc.) of latent variables by gradually adding noise to the initial solution. The initial solution may be represented as in (b) of FIG. 8, and the sequence of the latent variables may be represented as in (c) of FIG. 8. In the combinatorial optimization, the initial solution follows the optimized solution to the given instance, which may be represented as in (d) of FIG. 8.

These sequences are a continuation of solutions with gradually added noise. For example, the second sequence 402 (or the second solution with added noise) may contain more noise than the first sequence (403, or the first solution with added noise), and the third sequence 401 (or the third solution with added noise) may contain more noise than the first sequence 403 and the second sequence 402.

In addition, the solution 401 with fully added noise at a final (or last) point in time T of the forward noising process becomes a Bernoulli random variable and may follow the probability of the specific value (see (e) of FIG. 8). In this case, each variable is independent, which may be represented as in (f) of FIG. 8.

The forward noising process described above may be represented as in (g) of FIG. 8. Here, the initial state is sampled from the probability distribution defined according to the problem instance, and the probability distribution of the latent variable sequence (or noise sequence) generated from the initial solution may be represented as the product of the probabilities (transition probabilities) of generating the next state from the previous state at each point in time t.

Furthermore, the combinatorial optimization model 170 may be trained to gradually remove noise from the solutions 401, 402, and 403 with added noise through the backward denoising process, thereby restoring the solutions 401, 402, and 403 with added noise to solutions approximating the optimized solution 410. The combinatorial optimization model 170 may gradually restore the original solution by predicting the previous step at each state. That is, the combinatorial optimization model 170 may be trained to gradually remove noise from the solutions 401, 402, and 403 with added noise, thereby restoring the solutions 401, 402, and 403 to the solutions approximating the optimized solution 410. The backward denoising process may be treated identically to action selection in reinforcement learning, which will be described later.

The backward denoising process described above may be represented as illustrated in (h) of FIG. 8. During the supervised learning process, the control unit 180 may adjust the parameters of the combinatorial optimization model 170 so that the combinatorial optimization model 170 may approximate the conditional distribution of the optimized solution from the solution with added noise.

More specifically, the control unit 180 may optimize the parameters of the combinatorial optimization model 170 through the diffusion process so that the combinatorial optimization model 170 may gradually add noise to the optimized solution and restore the solution with added noise to the solution that well approximates the distribution of the optimized solution.

The control unit 180 may train the combinatorial optimization model 170 so that the probability distribution (see (a) of FIG. 9) sampled (or generated) from the combinatorial optimization model 170 well approximates the distribution of the optimal solution (see (b) of FIG. 9).

In this case, the control unit 180 may adjust the parameters of the combinatorial optimization model 170 by optimizing the first objective function for the supervised learning to minimize the distribution difference between the solution 404 restored from the combinatorial optimization model 170 and the optimized solution 410. For example, the first objective function may be optimized by minimizing an upper bound of variation of a negative log-likelihood. The first objective function may be represented as illustrated in (c) of FIG. 9.

In the combinatorial optimization, each item of the optimized solution indicates whether to select a node or an edge. When modeled using the Bernoulli distribution, each item may also be represented as a one-hot vector (see (e) of FIG. 11). Therefore, during the diffusion process, the optimized solution is converted into N one-hot vectors (see (f) of FIG. 11), and the diffusion-based combinatorial optimization model 170 may then be used.

Specifically, the transition process at each time step t may be represented as in (a) of FIG. 12. Here, the discrete category distribution for a probability vector p may be represented as in (b) of FIG. 12, and the transition probability matrix may be represented as in (c) of FIG. 12. In addition, the noise level at the time step t may be represented as in (d) of FIG. 12, and the marginal distribution of the time step may be represented as in (e) of FIG. 12. Here, the cumulative transition matrix is represented as in (f) of FIG. 12, and Bayes'theorem is applied to acquire the conditional probability distribution in the backward denoising process. This may be represented as illustrated in (g) of FIG. 12.

Furthermore, the combinatorial optimization model 170 trained to predict the reference solution included in the training dataset 200 may use the predicted value from the backward denoising process as a surrogate value for the optimized solution to calculate the posterior distribution (see (h) of FIG. 12). This calculation may be represented as in (i) of FIG. 12.

In embodiments of the invention, the backward denoising process of the supervised-learned combinatorial optimization model 170 may be modeled as a Markov Decision Process (“MDP”) by applying a decoder. This Markov Decision Process may be defined as a tuple (see (a) of FIG. 10).

Here, the state in the state space includes the combinatorial optimization instance, the current step (or time step), and the current state, as illustrated in (b) of FIG. 10. The action in the action space is a selection of the state of the previous step, as illustrated in (c) of FIG. 10. The state transition probability is represented as in (d) of FIG. 10, and the initial state distribution is a fully noised state and may be represented as illustrated in (e) of FIG. 10. The reward function is a cost criterion for the solutions satisfying the constraints processed by the decoder, and may be represented as in (f) of FIG. 10.

The objective of the reinforcement learning may be to learn a policy to maximize the cumulative reward (see (h) of FIG. 10). The policy is the probability distribution of the combinatorial optimization model 170, and the probability distribution may be determined by the parameters of the model. For example, learning a policy may also be understood as learning the parameters of the model. Maximizing the cumulative reward may be represented as in (i) of FIG. 10. Here, the state-action sequence generated by the policy within the MDP may be represented as in (j) of FIG. 10.

In embodiments of the invention, the backward denoising process in the diffusion process for combinatorial optimization may be modeled (or formulated) as the Markov decision process. This may be represented as illustrated in (a) of FIG. 11. Here, Bern(p) is a Bernoulli distribution with each element independently following the probability (p), that samples the initial noise (see (b) of FIG. 11), and a Dirac delta distribution may be a Dirac delta distribution whose density is nonzero only at y (see (c) of FIG. 11).

In addition, embodiments of the invention may apply a policy gradient algorithm (or “policy slope”,” policy inclination”, etc.) to optimize an iterative backward denoising process under a cost function. This may be represented as illustrated in (d) of FIG. 11. When the agent learns the proposed MDP in the correct way, the combinatorial optimization model 170 may consider the impact of the solution (e.g., a solution satisfying constraints) post-processed by the decoder on the objective function. More specific content thereof will be described below.

In embodiments of the invention, the supervised-learned combinatorial optimization model may be acquired using the training data (S330), and the process of reinforcement learning the supervised-learned combinatorial optimization model may be performed (S340, see FIG. 3).

In embodiments of the invention, the control unit 180 may acquire the supervised-learned combinatorial optimization model 170 using the training data (S355, see FIG. 3b). The control unit 180 performs learning of or trains (or adjusts) the parameters of the combinatorial optimization model 170 based on the supervised learning to approximate the conditional distribution of optimized solutions to instances, and acquires the trained (or learned or adjusted) parameters as a result of the supervised learning. The parameters acquired through the supervised learning may also be understood as the optimal parameters, and the control unit 180 may specify (or determine) the optimal parameters as parameters to be used in the reinforcement learning and set the optimal parameters as initial values.

In this regard, the control unit 180 may acquire the restored solution that approximates the optimized solution as a result of the supervised learning on the combinatorial optimization model 170. For example, as illustrated in FIGS. 4 and 5, the control unit 180 may acquire the restored solution 404 that approximates the optimized solution as a result of the supervised learning through the diffusion process of the combinatorial optimization model. The restored solution may be represented as illustrated in (d) of FIG. 9 and may also be understood as the solution ultimately sampled in the diffusion process.

As described above, the valid solution space may be a much smaller subset of the entire solution space (see (e) of FIG. 9). Here, the valid solution space is a set of solutions that satisfy the constraints for the given instance, and these constraints may vary depending on the type of combinatorial optimization problems (e.g., traveling salesman problem, maximum independent set problem, etc.).

The control unit 180 may convert (or modify) the restored solution 404 into the solution (or valid solution) that satisfies the preset constraints so that the restored solution 404 is included within (or belongs to) the valid solution space. The control unit 180 may use the decoder to convert the restored solution 404 into the solution that satisfies the preset constraints for the instance. In this case, the preset constraints may be set differently depending on the type (or definition) of the instance. For example, for an instance related to the traveling salesman problem, the constraints may be set so that each city is visited exactly once and that the user returns to the origin city after a tour. For another example, for an instance related to the maximum independent set problem, the constraints may be set so that a selected pair of vertices is not connected by an edge (independent set condition).

The control unit 180 may process the restored solution 404 as input to the decoder. The decoder may convert the restored solution 404 into the solution (e.g., a feasible solution) that satisfies the preset constraints so that the converted solution approximates the optimized solution. The decoder may convert the restored solution 404 into the solution that satisfies the constraints within a range close to the optimized solution. This may be understood as converting the restored solution 404 into the solution that satisfies the constraints while maintaining the structure (or form) as much as possible. The decoder is illustrated as in (f) of FIG. 9, and the solution converted by the decoder that satisfies the constraints may be illustrated as in (g) of FIG. 9.

The control unit 180 may acquire the solution that satisfies the constraints from the decoder and may perform reinforcement learning on the supervised-learned combinatorial optimization model 170 using the solution that satisfies the constraints (S357, see FIG. 3B).

The control unit 180 may use the cost function to calculate the cost for the solution that satisfies the constraints, and use the reward function to calculate the reward for the cost. The control unit 180 may provide (or assign) the reward calculated based on the cost for the solution satisfying the constraints to the supervised-learned combinatorial optimization model 170.

In this case, the reward may be provided for the restored solution 404 acquired as a result of the restoration of the supervised-learned combinatorial optimization model 170. The control unit 180 may provide the reward only for the final point in time corresponding to the point in time at which the solution approximating the optimized solution is restored during the backward denoising process of the supervised-learned combinatorial optimization model 170. In this case, the update of the parameters of the supervised-learned combinatorial optimization model 170 may be performed for each step of the backward denoising process, including the final point in time. The control unit 180 may update the parameters of the combinatorial optimization model 170 by multiplying the calculated reward value by the gradient (or slope, inclination) of each step of the backward denoising process. That is, the gradients of all steps in the backward denoising process are multiplied by the same reward value, thereby updating the policy (probability distribution) at all steps. Therefore, the reward is equally applied to the policy at all steps in the backward denoising process, thereby performing the reinforcement learning on the supervised-learned trained combinatorial optimization model 170.

Furthermore, the control unit 180 may perform the reinforcement learning on the supervised-learned combinatorial optimization model by simultaneously considering the solutions satisfying the constraints and the cost. The supervised-learned combinatorial optimization model 170 may be reinforced-learned to maximize the reward for the cost. The supervised-learned combinatorial optimization model 170 is trained based on a condition for maximizing the reward related to the cost.

The supervised-learned combinatorial optimization model 170 may be reinforced-learned to minimize the cost for the solutions satisfying the constraints while maximizing the reward.

The control unit 180 may learn the parameters of the supervised-learned combinatorial optimization model 170 by optimizing the second objective function so that the cost for the solutions satisfying the constraints is minimized. In this case, the parameters of the supervised-learned combinatorial optimization model 170 may be adjusted by maximizing the objective function so that the cost for the solutions satisfying the constraints is minimized while the reward for the cost is maximized.

In the reinforcement learning step, the parameters may be adjusted through the reinforcement learning-based fine-tuning (“RL fine-tuning”). That is, the control unit 180 may optimize the second objective function by performing the RL fine-tuning on the parameters of the supervised-learned combinatorial optimization model. As described above, the objective of the combinatorial optimization problem may also be changed from minimizing the cost of the solution directly generated by the model (see (h) of FIG. 9) and the value indicating whether the constraints are satisfied (see (i) of FIG. 9) to minimizing the cost of the solution that satisfies the constraints converted by the decoder. The second objective function may be represented as illustrated in (i) of FIG. 9.

That is, conventionally, when the solution generated by the model did not satisfy either the cost or the constraints, the learning itself was invalidated, making learning difficult. However, embodiments of the invention, convert the solution generated by the model into the solution that satisfies the constraints through the decoder and minimizes the cost therefor, thereby ensuring that the model is trained in a positive way.

In the reinforcement learning-based fine-tuning process according to embodiments of the invention, the combinatorial optimization system 100 may generate new training instances from a pre-specified instance distribution or sample the training instances from the instances included in the training dataset 200.

For example, the pre-specified (or defined) instance distribution refers to a set of probabilistic rules or generation conditions for generating problem instances of a specific combinatorial optimization problem. The information may be stored and present in the storage unit 140 (or memory). This distribution is used to control the structural characteristics, data format, size, and difficulty of the problem and may serve as the basis for dynamically sampling the training instances so that the model may be generalized in various situations.

That is, embodiments of the invention improve the generalization performance of the combinatorial optimization model 170 by generating new instances not present in the training dataset 200, thereby enabling the combinatorial optimization model 170 to adapt well to various types of problems.

In addition, in the reinforcement learning-based fine-tuning process according to embodiments of the invention, the control unit 180 may apply various learning techniques (or methods) to efficiently train the supervised-learned combinatorial optimization model 170.

The control unit 180 may fix a plurality of first layers 11 in the architecture of the graph neural network, which is the backbone network of the supervised-learned combinatorial optimization model 170, and update the parameters of only a specific layer (e.g., the last layer) among the plurality of layers. Additionally, the control unit 180 may selectively perform the fine-tuning by applying low-rank adaptation (“LoRA”) to the remaining layers, excluding the specific layer.

Here, the LoRA is a technique that assumes that the change in the parameters due to the model adaptation is low-rank, and models the change in the parameters of each linear weight (e.g., the linear layer weight (or weight matrix) of the model) of the model as the product of the plurality of (two) low-rank matrices. That is, the LoRA may refer to a technique that models the change in the weight matrix as the product of two low-rank matrices, thereby updating the model through the low-rank change instead of adjusting the overall weights.

The LoRA may be selectively applied depending on the situation (or case). Through this, embodiments of the invention may improve the learning speed of the model and reduce memory usage. In particular, embodiments of the invention may improve the performance of the supervised-learned model by selectively applying the LoRA depending on the situations.

As illustrated in FIG. 15, in the inference step, the combinatorial optimization method and system according to embodiments of the invention as described above may provide at least one solution to the instance input by the user to the user terminal (S1640) as an optimized solution through a process (S1610) of receiving the combinatorial optimization problem instance from the user terminal, a process (S1620) of processing the instance as input to the combinatorial optimization model trained through the supervised learning and reinforcement learning, and a process (S1630) of acquiring the optimized solution to the instance from the combinatorial optimization model.

In this case, the combinatorial optimization model (i.e., the combinatorial optimization model utilized in the inference process) finally trained in embodiments of the invention may also be named “cost-aware diffusion solvers (CADO)”.

In this regard, the combinatorial optimization model 170 trained using the learning method described above may be applied to various combinatorial optimization problems.

First, the combinatorial optimization model 170 may be applied to a printed circuit board (“PCB”) design optimization problem.

Specifically, pairs (mandatory connection pairs) that should be connected and pairs (prohibited connection pairs) that should not be connected may be present between the given nodes (or terminals). All connection paths should be kept as short as possible.

In addition, overlap between lines (wires) should be minimized, and constraints may be imposed to limit the number of overlaps to a certain number of layers or fewer. For example, the overlap between the lines is prohibited in a single layer, but an allowable overlap limit may be set for each layer when a multi-layer structure is used.

In this case, the combinatorial optimization model 170 according to embodiments of the invention may generate an optimized wiring plan (or optimized wiring path (i.e., optimized solution)) that i) connects the mandatory connection pairs with the shortest distance, ii) prevents the prohibited connection pairs from being connected, iii) satisfies constraints so that the number of overlaps for each layer is within the allowed limit, and iv) minimizes the total sum of the total wiring length. In this case, the instance input may include both inter-node connection requirements and wiring overlap constraints for each layer. In addition, it is possible to determine whether the wiring paths intersect with each other, and when the wiring paths exceed the allowed limit, readjust the paths to generate a final PCB wiring path that satisfies the constraints.

Furthermore, in consideration of the high computational burden of converting data into a graph when designing the PCB, the inventive concepts may design the PCB by performing the wiring in a way similar to (or approximating) human wiring through the image-based approach using the diffusion-based combinatorial optimization model 170.

Next, the combinatorial optimization model 170 may be applied to solve the traveling salesman problem (TSP) having the plurality of constraints.

As described above, the traveling salesman problem may be a problem of determining the order of visiting cities so that a salesman visits each city exactly once while minimizing a total travel distance, when the locations of the cities that the salesman should visit are given. In the traveling salesman problem, an instance may represent an ‘n’ number of cities to be visited. A solution to the instance may be represented as a matrix (binary matrix), and each element of the matrix may refer to whether travel occurs between specific cities. In the entire solution space, the valid solution space may be a set of valid TSP paths in which each city is visited exactly once. In this case, the objective function represents the total length of the given path, which should be minimized. That is, the objective value of the traveling salesman problem may be the total travel distance between cities.

In this case, additional conditions including at least one of a case where a specific visiting date is assigned to each city (e.g., a first city (City A) may only be visited on Mondays or Wednesdays), or a case where certain city pairs may not be visited consecutively (e.g., a third city (City C) may not be visited immediately after visiting the second city (City B)) may be set.

Under the plurality of constraints, the combinatorial optimization model 170 according to embodiments of the invention may produce (or generate) the optimized path (i.e., the optimized solution) that: i) visits all cities exactly once; ii) minimizes the total travel distance, iii) ensures that the visiting order satisfies the visiting date constraints of each city, and iv) does not violate the consecutive visit prohibition constraint.

To this end, the combinatorial optimization system 100 according to embodiments of the invention may process, as input, additional constraint data including information on available visiting dates for each city, in addition to a matrix indicating the possibility of traveling between cities and the cost. In addition, the decoder may verify whether the generated path violates the constraints, and when the violation is found through the verification results, the postprocessing may be performed by applying the possible corrected path to generate the final solution that satisfies the constraints.

Furthermore, the combinatorial optimization model 170 trained in embodiments of the invention may be utilized in various operating environments.

For example, the trained combinatorial optimization model 170 may be stored on the server (central server) linked to the combinatorial optimization system 100. The user may transmit the instance to the server through the user terminal, and the server may calculate the optimized solution and provide the calculated optimized solution to the user terminal 10. The server may rapidly process large-scale problems using high-performance computing devices such as a GPU, TPU, or NPU.

For another example, the trained combinatorial optimization model 170 may be lightweight and directly embedded in smartphones, tablets, edge devices, etc. The user may perform the combinatorial optimization process in real time on a local device without a network connection. For the terminal-specific optimization, the trained combinatorial optimization model 170 may apply pruning, quantization, etc., in consideration of memory capacity and computational performance.

For another example, the trained combinatorial optimization model 170 may be distributed through a third-party platform. The combinatorial optimization system 100 may deploy the model on platforms such as AWS SageMaker, Azure ML, and Google Vertex AI, thereby enabling the optimization results to be utilized in real time by various external systems through API calls.

In this way, the combinatorial optimization system according to embodiments of the invention may be flexibly applied to various industrial fields and service environments.

As described above, the combinatorial optimization model 170 may be configured to include an anisotropic graph neural network as the backbone network. In addition, the combinatorial optimization model 170 may include at least one of a node embedding layer, an edge embedding layer, a diffusion layer (or a diffusion process layer), and a decoder.

The node embedding layer and the edge embedding layer may each serve to receive node and edge characteristics and generate an initial embedding. Here, the characteristics of each node may include a node type, coordinates, connectivity, etc., and the edge characteristics may include a distance, connection weights, etc.

In addition, the diffusion process layer may serve to gradually add noise to the initial solution during the forward process and restore the optimized solution from the solution with added noise during the backward denoising process.

In addition, the anisotropic graph neural network may apply message passing to directionally model the interactions between the nodes. The node and edge embeddings may be updated simultaneously in the layer of the anisotropic graph neural network.

In addition, the decoder may verify and correct the generated solutions for various combinatorial optimization problems, ensuring the solutions meet their respective constraints (available visiting dates, connection limit, overlap limit, etc.)

Furthermore, in the supervised learning (SL) step, the combinatorial optimization model 170 may be trained to minimize the negative log-likelihood-based loss so as to approximate the conditional distribution similar to the optimized solution as much as possible. Next, in the reinforcement learning (RL) step, the combinatorial optimization model 170 may be trained to update parameters to maximize cumulative rewards through a policy gradient based on a reward function.

The training framework for the combinatorial optimization model 170 may be implemented on PyTorch, TensorFlow, or JAX, and can also extend to a quantum computing environment (QPU-based).

As described above, according to the combinatorial optimization system, its control method, and the learning method of a combinatorial optimization system according to the embodiments of the invention, it is possible to train the combinatorial optimization model using the supervised learning and the reinforcement learning. Through this, the combinatorial optimization model may generate the high-quality solutions which minimize costs for various combinatorial optimization problem instances while satisfying constraints. That is, according to the combinatorial optimization model according to embodiments of the invention, it is possible to save the computational resources and generate the optimized solution suitable for the problem, even for the high-dimensional problems with large solution spaces and complex constraints.

In addition, as described above, according to the combinatorial optimization system, its control method, and the learning method of a combinatorial optimization system according to embodiments of the invention, by reflecting the cost information of the solutions that satisfy constraints to perform the reinforcement learning on the combinatorial optimization model, it is possible to solve the combinatorial optimization problem and construct the combinatorial optimization model with high prediction accuracy and cost optimization performance. Through this, it is possible to generate the high-quality optimized solution while minimizing costs through the high optimization performance, regardless of the data quality or problem size. That is, the combinatorial optimization model according to embodiments of the invention can be universally utilized for various problem types and scales.

Furthermore, according to the combinatorial optimization system, its control method, and the learning method of a combinatorial optimization system according to embodiments of the invention, by performing the transfer learning on the supervised learning-based combinatorial optimization model based on the reinforcement learning, it is possible to achieve the robust performance on new instances with different problem scales without separate labeling. Accordingly, according to the combinatorial optimization model according to embodiments of the invention, it is possible to effectively respond to new problem instances even if there is no training data including the high-quality optimized solutions, and secure both the versatility and scalability for various combinatorial optimization problems. That is, according to embodiments of the invention, it is possible to improve the operation efficiency and save the memory resources while maintaining high performance without the performance degradation of the model. Through this, the inventive concepts can be applied and utilized in various fields and services, such as operation study, logistics optimization, manufacturing and production planning, semiconductor and chip design automation (e.g., PCB design, circuit design, etc.), communications and network design, and financial services.

Furthermore, according to the combinatorial optimization system, its control method, and the learning method of a combinatorial optimization system according to embodiments of the invention, by performing the transfer learning on the supervised learning-based combinatorial optimization model based on the reinforcement learning, it is possible to apply new instances with different problem scales without separate labeling. Accordingly, it is possible to effectively respond to new problem instances without additional high-quality training data, and simultaneously ensure both the versatility and scalability for the combinatorial optimization problem. Through this, the inventive concepts can be applied and utilized in various fields and services, such as operation study, logistics optimization, manufacturing and production planning, semiconductor and chip design automation (e.g., PCB design, circuit design, etc.), communications and network design, financial services, game, elevators, security (or patrol), and hospitals.

The inventive concepts described above may be implemented based on the quantum computer. Embodiments of the invention implemented based on the quantum computer may include a qubit-based quantum processor and quantum memory, as well as software and hardware interfaces optimized for quantum computing.

The quantum processor of a quantum computer utilizes qubits to efficiently perform complex computations through parallel processing, quantum entanglement, and quantum superposition, which cannot be achieved by the binary bits of classical computers. The quantum processor processes data using quantum gates and may provide exponential speedups for specific problems.

As described above, the inventive concepts may be implemented as a program that is executed by one or more processes on a computer and stored on a computer-readable medium (or recording medium).

Furthermore, as described above, the inventive concepts may be implemented as computer-readable codes or instructions on a medium recording the program. That is, the inventive concepts may be provided in the form of the program.

The computer readable medium may include all kinds of recording devices in which computer system-readable data is stored. An example of the computer readable medium may include a hard disk drive (HDD), a solid state disk (SSD), a silicon disk drive (SDD), a read only memory (ROM), a random access memory (RAM), a compact disk read only memory (CD-ROM), a magnetic tape, a floppy disk, an optical data storage, and the like.

Furthermore, the computer-readable medium may be the server or cloud storage that includes storage and may be accessed by the electronic device via communication. In this case, the computer may download the program according to the invention from the server or cloud storage via wired or wireless communication.

The computer program may reach the system 100 through various suitable transmission mechanisms. The transmission mechanism may be, for example, a computer-readable storage medium, a computer program product, a memory device, a recording medium such as a CD-ROM or DVD, or a product tangibly embodying a computer program. The transmission mechanism may be a signal configured to stably transmit a computer program over air or through an electrical connection. The system 100 may propagate or transmit the computer program as a computer data signal.

Furthermore, references to “computer-readable storage medium”, “computer program product”, “computer program tangibly embodied”, or the like, or “controller”, “computer”, or “processor”, or the like should be understood to encompass not only computers with various architectures, such as single/multiprocessor architectures and sequential (Von Neumann)/parallel architectures, but also specialized circuits, such as a field-programmable gate array (FPGA), an application-specific circuit (ASIC), a signal processing device, and other devices. References to computer programs, instructions, codes, or the like, shall be understood as including instructions for processors or software for programmable processors or firmware, such as configuration settings for a fixed-function device, a gate array, or a programmable logic device, or any programmable content for a hardware device.

Furthermore, in embodiments of the invention, the computer described above is an electronic device equipped with a processor, i.e., a central processing unit (CPU), and there are no particular limitations on its type.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A learning method of a combinatorial optimization system, the method being computerized and comprising:
specifying a training dataset including at least one combinatorial optimization problem instance and at least one reference solution corresponding to the instance;
performing supervised learning on a combinatorial optimization model using the training dataset;
acquiring a supervised-learned combinatorial optimization model based on the training data; and
performing reinforcement learning on the supervised-learned combinatorial optimization model.

2. The learning method of the combinatorial optimization system of claim 1, wherein:
at least one parameter of the combinatorial optimization model is learned based on the supervised learning;
the supervised learning is performed to approximate a conditional distribution of the reference solution corresponding to the instance included in the training dataset; and
the reinforcement learning is performed on the combinatorial optimization model using the parameter of the supervised-learned combinatorial optimization model.

3. The learning method of the combinatorial optimization system of claim 2, wherein the parameter of the combinatorial optimization model is learned so that a probability distribution of at least one solution sampled from the combinatorial optimization model approximates the conditional distribution of the reference solution.

4. The learning method of the combinatorial optimization system of claim 1, wherein:
in the performing of the supervised learning, the combinatorial optimization model is trained through a diffusion process; and
the diffusion process includes a forward noising process and a backward denoising process.

5. The learning method of the combinatorial optimization system of claim 4, wherein the combinatorial optimization model is trained to:
gradually add noise to the reference solution through the forward noising process to generate solutions with added noise; and
restore the solutions to a solution approximating the reference solution by gradually removing noise included in the solutions generated by the forward noising process through the backward denoising process.

6. The learning method of the combinatorial optimization system of claim 5, wherein the combinatorial optimization model is trained to approximate the conditional distribution of the reference solution from the solutions generated by the forward noising process.

7. The learning method of the combinatorial optimization system of claim 6, wherein the parameter of the combinatorial optimization model is learned by optimizing a first objective function to approximate the conditional distribution of the reference solution from the solutions generated by the forward noising process.

8. The learning method of the combinatorial optimization system of claim 5, wherein:
the solution restored to approximate the reference solution is acquired as a restoration result of the combinatorial optimization model; and
the restored solution is converted into a solution satisfying preset constraints for the instance using a decoder.

9. The learning method of the combinatorial optimization system of claim 8, wherein, in the performing of the reinforcement learning, the supervised-learned combinatorial optimization model is reinforced-learned using the solution satisfying the constraints.

10. The learning method of the combinatorial optimization system of claim 9, wherein the performing of the reinforcement learning includes:
calculating a cost for the solution satisfying the constraints using a cost function;
calculating a reward related to the cost using a reward function; and
providing the reward to the supervised-learned combinatorial optimization model.

11. The learning method of the combinatorial optimization system of claim 10, wherein, in the providing of the reward, the reward is provided for the restored solution acquired as the restoration result of the combinatorial optimization model.

12. The learning method of the combinatorial optimization system of claim 10, wherein, in the performing of the reinforcement learning, the reinforcement learning is performed on the supervised-learned combinatorial optimization model in consideration of the solution satisfying the constraints and the cost.

13. The learning method of the combinatorial optimization system of claim 12, wherein the supervised-learned combinatorial optimization model is trained based on a condition for maximizing the reward related to the cost.

14. The learning method of the combinatorial optimization system of claim 12, wherein the parameter of the supervised-learned combinatorial optimization model is learned by optimizing a second objective function to minimize the cost for the solution satisfying the constraints.

15. The learning method of the combinatorial optimization system of claim 14, wherein, in the performing of the reinforcement learning, the reinforcement learning-based fine-tuning (“RL fine-tuning”) is performed on the parameter of the supervised-learned combinatorial optimization model to optimize the second objective function.

16. The learning method of the combinatorial optimization system of claim 1, wherein, in the performing of the reinforcement learning, a training instance is generated from a distribution of a pre-specified instance or is sampled from the instances included in the training dataset.

17. A control method of a combinatorial optimization system, comprising:
receiving at least one combinatorial optimization problem instance from a user terminal;
processing the instance as input to a combinatorial optimization model trained through supervised learning and reinforcement learning;
acquiring at least one solution to the instance from the combinatorial optimization model; and
providing the at least one solution to the user terminal as an optimized solution.

18. The control method of the combinatorial optimization system of claim 17, wherein:
in the receiving of the combinatorial optimization problem instance, PCB data corresponding to the instance and including constraint information is received from a service page provided to the user terminal; and
in the acquiring of the at least one solution, an optimized path corresponding to the optimized solution is generated using the combinatorial optimization model, in which the optimized path wires terminals included in the PCB data at a minimum cost while satisfying the constraint information.

19. The control method of the combinatorial optimization system of claim 18, wherein, in the providing of the optimized solution to the user terminal, the optimized path, in which the terminals are wired at a minimum cost, while satisfying the constraints according to the constraint information, is provided to the user terminal.

20. A combinatorial optimization system comprising: a memory configured to store executable instructions and one or more processors configured to execute the executable instructions,
wherein the combinatorial optimization system is configured to:
specify a training dataset including at least one combinatorial optimization problem instance and at least one reference solution corresponding to the instance;
perform supervised learning on a combinatorial optimization model using the training dataset;
acquire a supervised-learned combinatorial optimization model based on the training data; and
perform reinforcement learning on the supervised-learned combinatorial optimization model.
